(19) United States
(12) Patent Application Publication
(10) Pub. No.: US 2002/0124449 A1
(43) Pub. Date: Sep. 12, 2002

(54) Multi-use graphics display enclosure assembly detachably attached with concealed means to and made integral with any of a variety of assembled artifacts, the decor insert in said enclosure subject to repeated changes by owner

(76) Inventor: D. James Hill, Medford, NJ (US)

Correspondence Address: D. James Hill, 24 Golfview Drive, Medford, NJ, 08055, US

(21) Appl. No.: 09/802,013

(22) Filed: Mar. 9, 2001

(51) Int. Cl. G09F 7/02

(52) U.S. Cl. 40/611

(57) ABSTRACT

A multi-purpose graphics display enclosure assembly comprised of a transparent shield, a decor insert or inserts, a backer plate therefor, and a frame configured to perimeter-retain the above against and removably snap over the perimeter of a base plate which is removably attached to a functional or decorative artifact by one of a variety of means that are concealed in or behind the assembled enclosure, said assembly planar surfaces of shield, decor, decor backer plate and base plate having aligned apertures for electric switches and/or receptacles or communication line outlets or the like, said base plate having additional apertures for detachable attachment fasteners with which to secure said base plate to any one of a variety of artifacts or surfaces. The same assembly, sans apertures in said assembly shield, decor insert and decor backer plate, wherewith said base plate may be detachably attached with various concealed means to any one of numerous artifacts or surfaces having no protuberances, both apertured and non-apertured assemblies having opaque, translucent or transparent frames, the latter having a slit centered in its entire back surface for optional color insert.

### BACKGROUND OF THE INVENTION

The basic engineering design of two of the most common home and office artifacts, wall plates and picture frames, is obsolete.

Wall plates, commonly referred to as switch plates and/or receptacle plates, are mandated by law in every nation where electricity is available, are commonly attached to switches and receptacles with highly visible and unsightly screws, and cannot be personalized or customized to fit the character of the home or office occupant, nor can they be customized or otherwise changed to blend with the wall covering or other room decor.

Picture frames are commonly assemblies of unlimited and disparate frame decor, materials, sizes and colors, often perforated or of open wire, etc.

The primary, if not only reason for the frame, i.e., the picture or other decor insert that is enclosed, is commonly overwhelmed by the gaudiness or the seeming primacy of the frame. As important, current picture frames are designed to only hang on a wall or sit on a desk or shelf. They are not designed in standard sizes for diverse use, to function with apertures as switch/receptacle plates, to attach without apertures to common home and office artifacts such as bread boxes, napkin holders, book ends, awards products, file folder holders or magnetized to attach to numerous metal products and the like. Also inhibiting the use of conventional picture frames for such use is the conventional frame design which commonly requires that the decor insert, the enclosed picture, can only be changed from the back.

Clearly, the combination of concealed attachment means and possible frequent changes of the enclosed decor, be it a picture, drawing, pressed flowers or what have you, requires an assembly in which the rear part of the assembly is attached to those various artifacts, and the front part of the assembly, the frame and shield, professionally attach to the that rear part that is held in place by concealed fastening means such as flathead screws.

While the “picture frame look” of the graphics display-enclosure assembly used in variations of this invention has, with the exception of the apertures in the switch and/or receptacle plates, a commonality of size and finished look, numerous sizes, shapes and simple frame designs are possible without leaving the design and engineering principles on which this invention is based.

All of the frames in the variations of this invention are designed to be transparent, some of them with custom color insert channels that allow the buyer to custom color the frame, and then to change the color or omit any color if they so desire.

### SPECIFICATION

A multi-use graphics display-enclosure assembly comprised of

1. a base plate detachably attachable with concealed means over and to other artifact assemblies;

2. a decor insert-backer plate;

3. one or more decor inserts;

4. a transparent shield;

5. a frame that peripherally encloses said base plate, decor backer plate, inserts and shield, and unites them into a unit that is integral with artifact assembly to which said unit is attached,

6. a variety of concealable attachment means.

(A) 1 may have functional apertures therein;

(B) 2, 3 and 4 may or may not have functional apertures therein;

(C) 4 and 5 may be integral;

(D) 5 may be transparent or opaque;

(E) 5, if transparent, may or may not have a custom color insert channel;

(F) 5 may or may not have, if 5 and 4 are integral, the lower frame channels to give access to a frame extraction hook;

(G) 4 may or may not have two-dimensional graphics or three-dimensional figures detachably attached to its face;

(H) 5, latching nodes, while paired on each side, are offset from the three pairs on other sides to, by turning the frame 90, 180 or 270 degrees before snapping it over 1, 2, 3 and 4, virtually eliminate the wear on the node latching points on the periphery of 1 that could be caused by hundreds of assembly-disassembly cycles, if the nodes were identically positioned on all four sides.

### BRIEF DESCRIPTION OF THE DRAWINGS

FIG. 1 is a front elevational view of a straight-sided configuration of a double switch plate illustrating but one embodiment of this invention.

FIG. 2 is a front elevational view of an oval-sided configuration of a single switch plate illustrating another embodiment of this invention.

FIG. 3 is a front elevational view of another embodiment of this invention integrating a wood holder of file folders, books, napkins or the like with this graphics display-enclosure assembly.

FIG. 4 is a side elevational view of this embodiment of this invention.

FIG. 5 illustrates, in cross-sectional detail, one configuration of the periphery of one embodiment of the graphics display-enclosure assembly element of this invention.

FIG. 6 illustrates, in cross-sectional detail, another configuration of the periphery of another embodiment of the graphics display-enclosure assembly element of this invention.

FIG. 7 illustrates, in cross-sectional detail, another configuration of the periphery of another embodiment of the graphics display-enclosure assembly element of this invention, this element having a three dimensional shield.

FIG. 8 is a front elevational view of an embodiment of a graphics display-enclosure element of this invention illustrating only one configuration of a base plate and frame with one assembly and attachment means delineated thereon.

FIG. 9 illustrates a front elevational view of one embodiment of the graphics display-enclosure assembly element of this invention having an award ribbon, decorative ring and medallion removably attached thereto and thereby made an integral part of the assembled whole.

FIG. 10 illustrates an exploded cross-sectional detailed side view of the individual segments of the embodiment of this invention as delineated in FIG. 9.

FIG. 11 is a side view of the assembled configuration of this embodiment of this invention as delineated in FIG. 9 and FIG. 10.

FIG. 12 is a front elevational view of the tool used to initiate the disassembly of one configuration of the graphics display-enclosure as illustrated in FIG. 7.

FIG. 13 illustrates, in cross-sectional detail, another configuration of the periphery of yet another embodiment of the graphics display-enclosure assembly element of this invention.

FIG. 14 is a front elevational view of another embodiment of this invention, further illustrating the diverse combinations of various artifacts that can be combined to fit the scope of this invention.

FIG. 15 is a front elevational view of interlocking combinations of another embodiment of this invention as delineated in FIG. 14.

### DETAILED DESCRIPTION OF THE DRAWINGS

FIG. 1 illustrates a front elevational view of one preferred configuration of a graphics display-enclosure switch plate assembly with frame 1, wood veneer insert sans shield 33, and two switch apertures 20, this embodiment of a wall plate having straight sides.

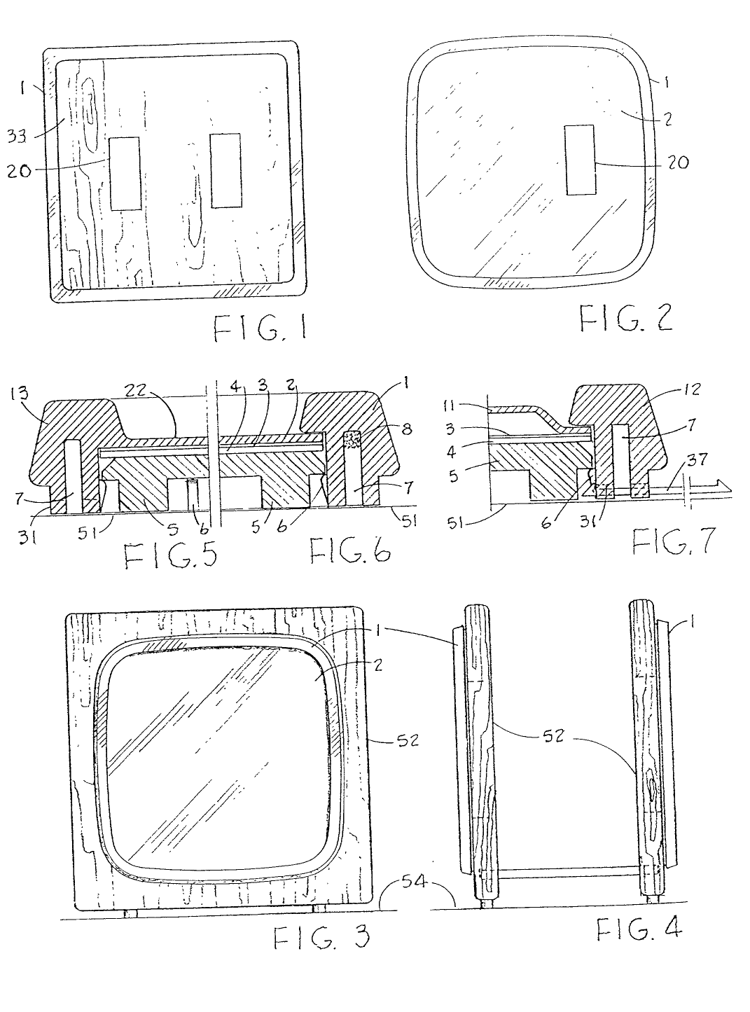

FIG. 2 is a front elevational view of another preferred configuration of a graphics display-enclosure switch plate assembly with frame 1, transparent shield 2, and a switch aperture 20, this embodiment of a wall plate having oval sides.

FIG. 3 is a front elevational view of this invention as but one integrated combination of one configuration of two graphics display-enclosure assemblies detachably secured with concealed means to a wood holder assembly 52 of desk-top 54 file folders, table-top napkins, being-read books and the like. The two graphics display-enclosures are simply delineated by the detachable frame 1 and transparent shield 2, this embodiment of the graphics display-enclosure having no visible apertures.

FIG. 4 is an end elevational view of this embodiment of this invention illustrating again the detachable frames 1, transparent shield 2 and holder assembly 52 sitting on a table or desk top 54.

FIG. 5 is a detailed cross-sectional view of one configuration of a frame 13 with integral shield 22, the transparent frame 13 having the color insert channel 7, disassembly-hook channel 31, frame-latching nodes 6, base plate 5 and wall 51.

FIG. 6 is a detailed cross-sectional view of another configuration of a frame 1 with separate transparent shield 2, decor insert 3, decor plate 4, base plate 5, frame-latching nodes 6, color insert channel 7, a color insert 8 and wall 51.

FIG. 7 is yet another detailed cross-sectional view of a frame 12, color insert channel 7, and disassembly-hook 37. This cross section also illustrates a three-dimensional shield 11, decor insert 3, decor plate 4, base plate 5 and frame-latching nodes 6, this assembly having a three-dimensional shield 11 to accommodate a three-dimensional decor which might, for example, include a butterfly or flowers attached to a conventionally thin, two-dimensional insert 3.

FIG. 8 is a skeletonized front elevational view of one embodiment of a graphics display-enclosure sans decor plate, decor and decor shield, this to illustrate the offsetting relationship of each pair of latching nodes, i.e., AA, AB, BB, BC, CC, CD, DD, DA, and AA-CC, BB-DD, all listed as 6 on this drawing. Said frame-latching nodes 6, all parts of the lower inside of the frame 1 but latching onto the periphery of the base plate 5 in which are shown toggle switch apertures 20 and attachment means apertures 32.

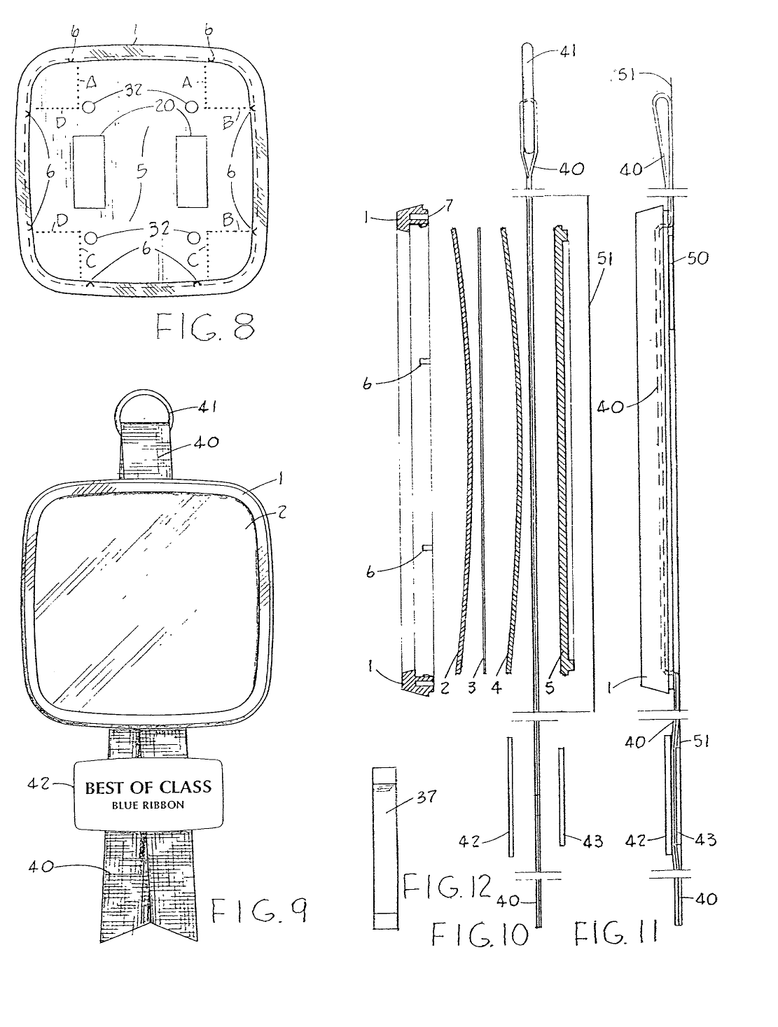

FIG. 9 is a front elevational view of one embodiment of this invention illustrating a graphics display-enclosure assembly of which only the frame 1 and shield 2 are shown on a top-fold ribbon 40 to which is attached, by entwining, said graphics display-enclosure assembly. The top-fold ribbon 40 hangs from a brass or other metal ring 41, and one example of a laudatory medallion 42 is, by concealed means, attached to ribbon 40 under the graphics display-enclosure assembly.

FIG. 10 illustrates a disassembled view of this embodiment of this invention as shown assembled in FIG. 9.

The ribbon 40 is shown forward of the base plate 5 and display plane 51, be that plane a conventional wall, a glass panel or other material plane. Forward of the ribbon 40 is the decor plate 4, decor insert 3 which in the illustrated embodiment would be a photograph, in front of which is the transparent shield 2 and the frame 1 with frame-latching nodes 6 and color insert channels 7. The ribbon 40 is top-folded through ring 41. A medallion 42 of brass-coated steel 42 is attached to ribbon 40 with a magnet 43 behind said ribbon 40.

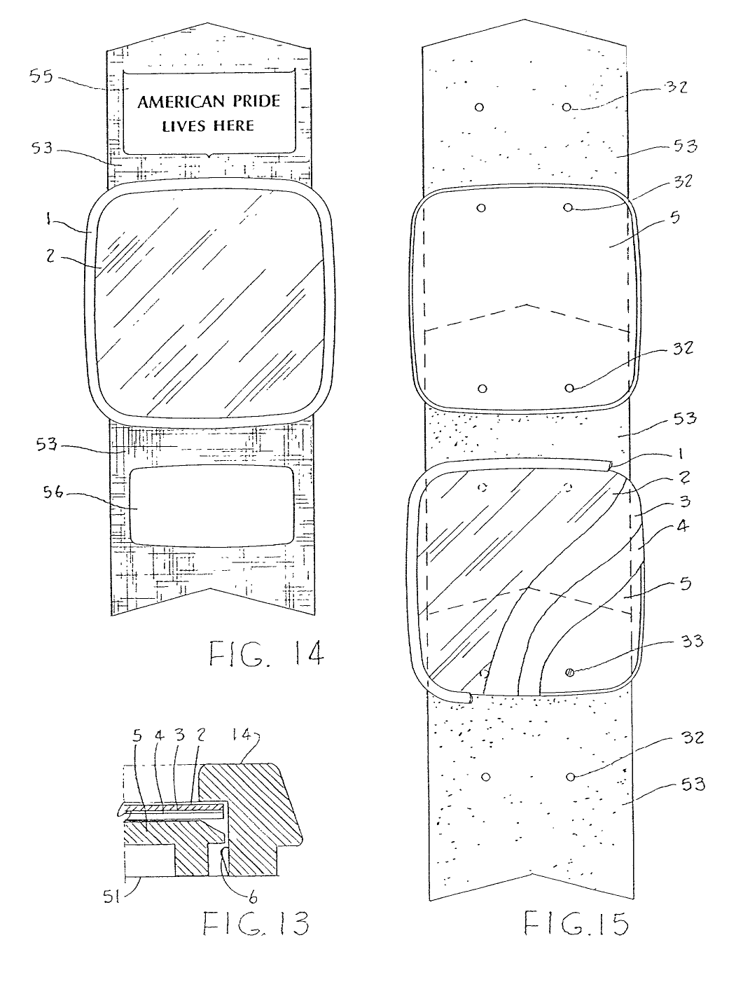

FIG. 11 illustrates a side view of all of the components delineated in the disassembly in FIG. 10, fully assembled excepting the ring 41, showing the ribbon 40 entwined within the assembly which is removably attached to a wall plane 51 with a concealed hanging device 50 adhered to the back of the base plate 5. This illustration of the assembly delineates the medallion 42 removably attached to ribbon 40 with a magnet 43 concealed behind the medallion 42 and ribbon 40.

FIG. 12 is a front elevational view of the disassembly hook 37 first illustrated in a side view in FIG. 7.

FIG. 13 is another detailed sectional view of a frame 14 assembled over a base plate 5 with frame-latching nodes 6, said frame peripherally enclosing the shield 2, decor insert 3 and decor plate 4, and joining these components into a functional unit that can be detachably attached to a wall 51.

FIG. 14 illustrates another embodiment of this invention showing a frame 1 and transparent shield 2, these the visible components of the complete graphics display-enclosure assembly which is detachably attached by concealed means to a two piece rigid wood or plastic backer 53 on which are also removably attached with concealed means medallions 55 and 56.

FIG. 15 illustrates a modular, or multiple assembly of this embodiment of this invention, employing cutaway drawings to delineate the graphics display-enclosure base plate 5, decor plate 4, decor insert 3, transparent shield 2, and frame 1. A rigid wood or plastic backer 53 having apertures 32 for means to attach graphics display-enclosure base plates 5 thereto with attachment screws 33 shown in the cutaway drawing base plate 5.

The apertures 32 in the rigid backer 53 are for the detachable attachment of generic medallions such as 55 in FIG. 14, and personal-specific medallions 56 under the graphics display-enclosure assembly.

The rigid backer 53 sections are sized and apertured to assemble into multiples when joined by concealed means in the apertures 32 in the base plate 5 matched with apertures 32 in the rigid backer 53.

### CONSPECTUS

The heart of this invention, the multi-use graphics display-enclosure assembly, was designed to supply a broad market with an innovative product which, because the only two parts of the attached assembly that are visible, the frame and the shield, are transparent, thus cannot be the wrong color or character. The buyer supplies and simply inserts the desired color in the frame color channel, and chooses the character and color of the decor insert.

If the buyer wants a different frame color, the color insert is easily changed. If the buyer wants no frame color, they simply leave the frame as they buy it, transparent.

If the buyer doesn't like their initial choice of insert decor, they simply change it.

If the buyer wishes to redecorate a home or office, change a nursery to a kindergartner's domain, make a just-married 21 year old offspring's room an office, or if they are just tired of the year-old wall plate decor, no problem, they simply change that insert. They do not have to shop for a new wall plate, they create it.

The decor insert is protected by an easy-to-keep-clean transparent shield, and the custom color insert channel is similarly protective of that frame insert.

The drawings illustrate only a double switch, switch-receptacle or double receptacle plate width, even for single switches and single receptacles. The single switch or single receptacle aperture asymmetrically located on a double plate width assembly is a deliberate design decision, this to give the buyer/owner the meaningful space for the decor insert, be that insert a child's drawing, a botanical print, genuine wildflowers or a butterfly, ad infinitum. Single switch and single receptacle plates are included within the scope of this invention.

These multi-use graphics display-enclosure assemblies are designed to be, with concealed means, detachably attached to numerous artifacts commonly utilized in the home and office, thereby creating new entities that can be simply and professionally personalized or customized, and as easily changed, “redecorated”, by the buyer or owner.

Broadly, graphics display-enclosure assemblies may be classified:

A. with apertures of various sizes and shapes, commonly used as switch and/or receptacle plates, communications outlet plates and the like, and

B. sans apertures, commonly attached to holders of napkins and file folders, to book ends, to award assemblies and the like.

Magnetized, they attach to file cabinets, refrigerators and the like.

The design principles of this multi-use graphics display-enclosure assembly, whether used with apertures as a wall plate or sans apertures detachably attached to ancillary assemblies such as a holder for file folders, napkins and the like, cover and protect all sizes and configurations of graphics display assemblies, whether the display is enclosed as an insert or attached to the face of the shield, that embody the principles delineated and described in this invention.

What is claimed is:

1. A graphics display enclosure assembly comprising:
a. a transparent frame of a configuration that encompasses and, with in-facing rim circumscribing said frame, contains-in-place other elements of the assembly including but not limited to
b. a transparent, concave plastic shield which covers, protects and holds immobile thereunder
c. one or more decorative graphic inserts, wood veneer, brass or the like, which singly or in combination equal the planar area of said shield,
d. behind said graphic or other inserts being a concave opaque plastic backer-plate of a size and configuration identical with said transparent shield,
e. behind described subassembly of frame, transparent shield, insert(s) and backer-plate, and detachably attached thereto by spaced nubs on the lower inside of said frame latching over the extended lip of a base-plate configured to be screw-secured or otherwise detachably attached to
f. any appropriate artifact base having a firm planate surface area proximate to, equaling or exceeding the area of said graphics display enclosure assembly.

2. A graphics display enclosure assembly as in claim 1 wherein said transparent frame and shield are integral, a single entity.

3. A graphics display enclosure assembly frame where said frame's back perimeter is circumscribed by a shallow undercut.

4. A graphics display enclosure frame as in claim 1 having in-facing latching nubs with in-facing surfaces sloping to near-flat ledge ends, all of which latch under said base-plate's periphery edges in detachably attaching said frame containing assembly's shield, insert and backer-plate over and to assembly's base-plate.

5. A graphics display enclosure assembly wherein the frame encompasses and contains-in-place a transparent shield, decor, decor backer-plate and base-plate all having aligned apertures within which fit with close tolerance individually identical or varied configuration switches and/or receptacles, phone or other communications jacks and the like.

6. A graphics display enclosure assembly frame as in claim 1 wherein each of the 2 or more in-facing nubs on each of said frame's sides are fractionally offset laterally from each other nub thereon.

7. A graphics display enclosure assembly frame as in claim 1 wherein a narrow slot circumscribes the approximate center of the entire back side of said frame.

8. A graphics display enclosure assembly frame as in claim 1 wherein there are 4 or more channels transverse to said frame's back periphery, of a depth equal to said undercut circumscribing frame's back perimeter.

9. A graphics display enclosure assembly as in claim 1 wherein said shield is glass.

10. A graphics display enclosure assembly as in claim 1 wherein the shield is cross-sectionally configured with 2 planes, a peripheral plane contained within in-facing frame rim, and having an elevated plane remainder of said shield.

11. A graphics display enclosure assembly as in claim 1 wherein 3-dimensional, flat-backed decorative figures are detachably attached to the front surface of said assembly's shield.

12. A graphics display enclosure wherein a decor overlay comprised of ¼″ or thicker wood, marble or other material, with or without decorative printing thereon or utilitarian apertures therein, is removably adhered to a decor plate backer-plate the periphery of which is detachably attached to a base-plate by a circumscribing frame, the in-facing nubs on which latch over the edges of said base-plate.

13. A graphics display enclosure assembly wherein said assembly is detachably attached to a pliant ribbon or ribbons via which said assembly is detachably attached to any appropriate vertical planate surface having a width proximate to, equaling or exceeding the area of said graphics display enclosure assembly.

14. A graphics display enclosure assembly as in claim 2 wherein said pliant ribbon penetrates said assembly and is securely gripped by assembly's frame snapped over assembly's base-plate.

15. A graphics display enclosure assembly as in claim 2 wherein a plurality of assemblies are detachably interconnected along said assemblies vertical axes.

16. A graphics display enclosure assembly as in claim 1 wherein said frame is translucent.

17. A graphics display enclosure assembly as in claim 1 wherein said frame is opaque.

18. A graphics display enclosure assembly as in claim 8 wherein a flat tool having splayed ends forming hooks, with width limited by frame's channels in claim 8, with thickness limited by frame's undercut in claim 3, is insertable through any frame channel to initiate, if necessary, the detachment of assembly's frame to release all enclosures therein.
